(19) United States
(12) Patent Application Publication
(10) Pub. No.: US 2026/0056566 A1
(43) Pub. Date: Feb. 26, 2026

(54) REFERENCE VOLTAGE GENERATION CIRCUIT

(71) Applicants: Toshiya KAMIBAYASHI, Tokyo (JP); Yoshihiro TAKAHASHI, Tokyo (JP)

(72) Inventors: Toshiya KAMIBAYASHI, Tokyo (JP); Yoshihiro TAKAHASHI, Tokyo (JP)

(73) Assignee: MITSUMI ELECTRIC CO., LTD., Tokyo (JP)

(21) Appl. No.: 19/282,047

(22) Filed: Jul. 28, 2025

(30) Foreign Application Priority Data
Aug. 23, 2024 (JP) 2024-143425

(51) Int. Cl. G05F 1/46; G05F 1/445; G05F 1/567; G05F 1/585

(52) U.S. Cl. CPC G05F 1/468; G05F 1/445; G05F 1/567; G05F 1/585

(57) ABSTRACT

A reference voltage generation circuit includes an output terminal that outputs a reference voltage; first and second bipolar transistors connected between first and second power supply terminals, bases of the first and second bipolar transistors being connected to the output terminal; a first resistor connected between the second power supply terminal and the first bipolar transistor; a second resistor connected in series between the first resistor and the second bipolar transistor; a third resistor connected between the first power supply terminal and the first bipolar transistor; a fourth resistor connected between the first power supply terminal and the second bipolar transistor; an amplifier using the collectors of the first and second bipolar transistors as input, an output of the amplifier being connected to the output terminal; and a temperature compensation circuit that corrects a current of the collector or emitter of the second bipolar transistor or the first bipolar transistor.

### CROSS-REFERENCE TO RELATED APPLICATIONS

This application is based on and claims priority to Japanese Patent Application No. 2024-143425, filed on Aug. 23, 2024, the entire contents of which are incorporated herein by reference.

### BACKGROUND OF THE INVENTION

### 1. Field of the Invention

The present disclosure relates to a reference voltage generation circuit.

### 2. Description of the Related Art

Patent Document 1 discloses a technique of providing a current correction circuit for suppressing temperature dependence of a reference voltage in a semiconductor integrated circuit including a band gap reference voltage circuit.
Patent Document 2 discloses a technique of providing a temperature correction circuit in a band gap reference circuit.

### RELATED-ART DOCUMENTS

### Patent Documents

[Patent Document 1] Japanese Patent Publication No. 6716918
[Patent Document 2] Japanese Patent Publication No. 5965528

### SUMMARY OF THE INVENTION

According to one embodiment of the present disclosure, a reference voltage generation circuit includes an output terminal configured to output a reference voltage; a first bipolar transistor and a second bipolar transistor, both of which are connected between a first power supply terminal and a second power supply terminal, a base of the first bipolar transistor and a base of the second bipolar transistor being connected to the output terminal; a first resistor connected between the second power supply terminal and an emitter of the first bipolar transistor; a second resistor connected in series between an end of the first resistor and an emitter of the second bipolar transistor, the end of the first resistor being connected to the emitter of the first bipolar transistor; a third resistor connected between the first power supply terminal and a collector of the first bipolar transistor; a fourth resistor connected between the first power supply terminal and a collector of the second bipolar transistor; an amplifier using the collector of the first bipolar transistor and the collector of the second bipolar transistor as input, an output of the amplifier being connected to the output terminal; and a temperature compensation circuit configured to correct a current of the collector or emitter of the second bipolar transistor or a current of the collector or emitter of the first bipolar transistor.

### BRIEF DESCRIPTION OF THE DRAWINGS

FIG. 1 is a diagram illustrating an example of a circuit configuration of a reference voltage generation circuit according to a first embodiment;

FIG. 2 is a graph indicating an example of the temperature characteristic of a band gap reference voltage in a reference voltage generation circuit of a comparative example;

FIG. 3 is a graph indicating an example of the temperature characteristic of a band gap reference voltage in the reference voltage generation circuit according to the first embodiment;

FIG. 4 is a diagram illustrating a first modified example of the circuit configuration of the reference voltage generation circuit according to the first embodiment;

FIG. 5 is a diagram illustrating an example of a circuit configuration of a reference voltage generation circuit according to a second embodiment;

FIG. 6 is a graph indicating an example of the temperature characteristic of a band gap reference voltage in the reference voltage generation circuit according to the second embodiment;

FIG. 7 is a diagram illustrating a second modified example combining the first and second embodiments;

FIG. 8 is a diagram illustrating an example of a circuit configuration of a reference voltage generation circuit according to a third embodiment;

FIG. 9 is a graph indicating an example of the temperature characteristic of a band gap reference voltage in the reference voltage generation circuit according to the third embodiment;

FIG. 10 is a diagram illustrating an example of an equivalent circuit configuration of the reference voltage generation circuit according to the third embodiment;

FIG. 11 is a graph indicating an example of the temperature characteristic of the current ratio α of currents I3 to I4 in the equivalent circuit illustrated in FIG. 10;

FIG. 12 is a graph indicating an example of a high-order component of the voltage V2 generated in a second resistor R2 in the equivalent circuit illustrated in FIG. 10;

FIG. 13 is a graph indicating an example of a high-order component of the temperature characteristic of each voltage in the equivalent circuit illustrated in FIG. 10;

FIG. 14 is a diagram illustrating an example of a layout of transistors provided in the reference voltage generation circuit according to the first embodiment; and

FIG. 15 is a diagram illustrating an example of a circuit configuration of the reference voltage generation circuit according to the comparative example.

### DESCRIPTION OF THE EMBODIMENTS

In the techniques of Patent Documents 1 and 2, it is required to adjust the correction amount of the second-order temperature characteristics in accordance with the variation of element characteristics in a manufacturing process.

According to a reference voltage generation circuit of an embodiment, the temperature characteristic of a band gap reference voltage can be improved.

Embodiments will be described below with reference to the drawings.

### First Embodiment

### (Circuit Configuration of Reference Voltage Generation Circuit 100)

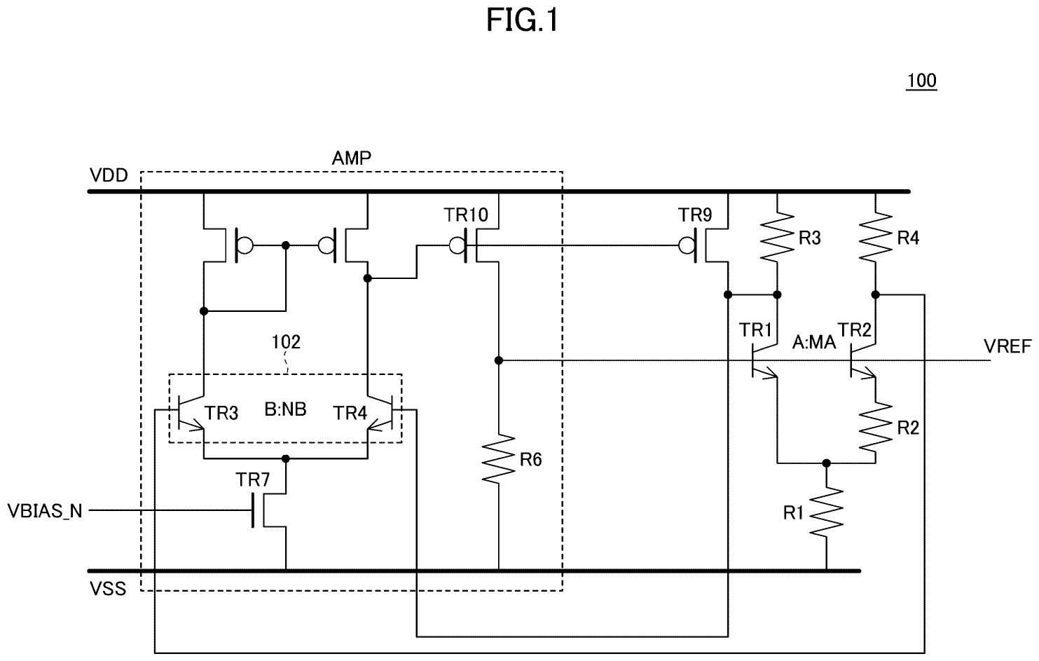

FIG. 1 is a diagram illustrating an example of a circuit configuration of a reference voltage generation circuit 100 according to a first embodiment. The reference voltage generation circuit 100 illustrated in FIG. 1 is configured based on what is known as a Brokaw-type band gap reference voltage generation circuit, and is a circuit that generates a band gap reference voltage and outputs the band gap reference voltage from an output terminal VREF.

As illustrated in FIG. 1, the reference voltage generation circuit 100 according to the first embodiment includes a first bipolar transistor TR1, a second bipolar transistor TR2, a first resistor R1, a second resistor R2, a third resistor R3, a fourth resistor R4, and an amplifier AMP.

The first bipolar transistor TR1 is, for example, an NPN-type transistor, connected between a first power supply terminal VDD and a second power supply terminal VSS, and the base is connected to the output of the amplifier AMP and the output terminal VREF.

The second bipolar transistor TR2 is, for example, an NPN-type transistor, connected between the first power supply terminal VDD and the second power supply terminal VSS, and the base is connected to the output of the amplifier AMP and the output terminal VREF.

The emitter area ratio of the first bipolar transistor TR1 to the second bipolar transistor TR2 is A:M*A with different current densities. Here, A is a real number greater than or equal to 1, and M is a real number greater than 1. For example, A:M*A=1:8.

The first resistor R1 is connected between the second power supply terminal VSS and the emitter of the first bipolar transistor TR1.

The second resistor R2 is connected in series between the end of the first resistor R1 that is connected to the emitter of the first bipolar transistor and the emitter of the second bipolar transistor TR2.

The third resistor R3 is connected between the first power supply terminal VDD and the collector of the first bipolar transistor TR1.

The fourth resistor R4 is connected between the first power supply terminal VDD and the collector of the second bipolar transistor TR2.

The amplifier AMP is a two-stage amplifier connected between the first power supply terminal VDD and the second power supply terminal VSS. One input of the first stage of the amplifier AMP is connected to the collector of the first bipolar transistor TR1. The other input of the amplifier AMP is connected to the collector of the second bipolar transistor TR2. Additionally, the amplifier AMP includes a long-tailed pair (emitter coupling pair) including transistors TR3 and TR4. The control terminal of the transistor TR3 is an inverting input, and the control terminal of the transistor TR4 is a non-inverting input.

The second stage of the amplifier AMP is connected between the first power supply terminal VDD and the second power supply terminal VSS, and has a configuration in which a PMOS transistor TR10 and a sixth resistor R6 are connected in series. Specifically, one end of the PMOS transistor TR10 is connected to the first power supply terminal VDD, and the other end of the PMOS transistor TR10 is connected to the sixth resistor R6. Additionally, one end of the sixth resistor R6 is connected to the other end of the PMOS transistor TR10, and the other end of the sixth resistor R6 is connected to the second power supply terminal VSS. The control terminal of the PMOS transistor TR10 is connected to the collector of the transistor TR4. The drain of the PMOS transistor TR10 is an output terminal of the amplifier AMP and is connected to the output terminal VREF. That is, the output of the amplifier AMP is connected to the base of the first bipolar transistor TR1, the base of the second bipolar transistor TR2, and the output terminal VREF. Here, the reference voltage generation circuit 100 actually includes a phase compensation circuit and a start-up circuit, but the illustration and explanation thereof are omitted in the present specification.

Here, the reference voltage generation circuit 100 according to the first embodiment includes a first current source connected to the collector of the first bipolar transistor TR1 as an example of a temperature compensation circuit for correcting the current of the collector of the first bipolar transistor TR1.

In particular, the reference voltage generation circuit 100 according to the first embodiment includes, as an example of the first current source, a transistor TR9. One end of the transistor TR9 is connected to the first power supply terminal VDD and the other end of the transistor TR9 is connected to the collector of the first bipolar transistor TR1, and the non-inverting input of the amplifier AMP (the control terminal of the transistor TR4) and the control terminal of the transistor TR9 is connected to the control terminal of the PMOS transistor TR10.

With this, the reference voltage generation circuit 100 according to the first embodiment can improve the temperature characteristic of the band gap reference voltage by correcting the current of the collector of the first bipolar transistor TR1 in accordance with a change in the environmental temperature. Additionally, the reference voltage generation circuit 100 according to the first embodiment does not use a comparator, amplifier, or the like for the temperature compensation circuit, and thus an increase in power consumption caused by the addition of the temperature compensation circuit can be suppressed.

In the reference voltage generation circuit 100 according to the first embodiment, the amplifier AMP includes an asymmetric differential pair 102 including the transistor TR3 having the inverting input (i.e., the inverting input transistor TR3) and the transistor TR4 having the non-inverting input (i.e., the non-inverting input transistor TR4). The inverting input transistor TR3 and the non-inverting input transistor TR4 are both NPN-type transistors. In the differential pair 102, the emitter area ratio of the inverting input transistor TR3 to the non-inverting input transistor TR4 is B:N*B. Here, B is a real number greater than or equal to 1, and N is a real number greater than 1. For example, B:N*B=1:8. Here, it is not necessary that the emitter area ratio of the inverting input transistor TR3 to the non-inverting input transistor TR4 is B:N*B, as long as the emitter current density ratio is N*B:B. This is because substantially the same effect can be obtained if the emitter current density ratio of the inverting input transistor TR3 to the non-inverting input transistor TR4 becomes N*B:B.

In the reference voltage generation circuit 100 according to the first embodiment, the collector of the first bipolar transistor TR1 having the emitter area ratio A (for example, 1) is connected to the base of the non-inverting input transistor TR4 having the emitter area ratio N*B (for example, 8), and the collector of the second bipolar transistor TR2 having the emitter area ratio M*A (for example, 8) is connected to the base of the inverting input transistor TR3 having the emitter area ratio B (for example, 1). As described above, instead of the emitter area ratio, as long as the ratio of the current density of the emitter of the first bipolar transistor TR1 to the current density of the emitter of the second bipolar transistor TR2 becomes M*A: A, substantially the same effect can be obtained.

With this, the reference voltage generation circuit 100 according to the first embodiment can suppress manufacturing variations in the temperature characteristic correction.

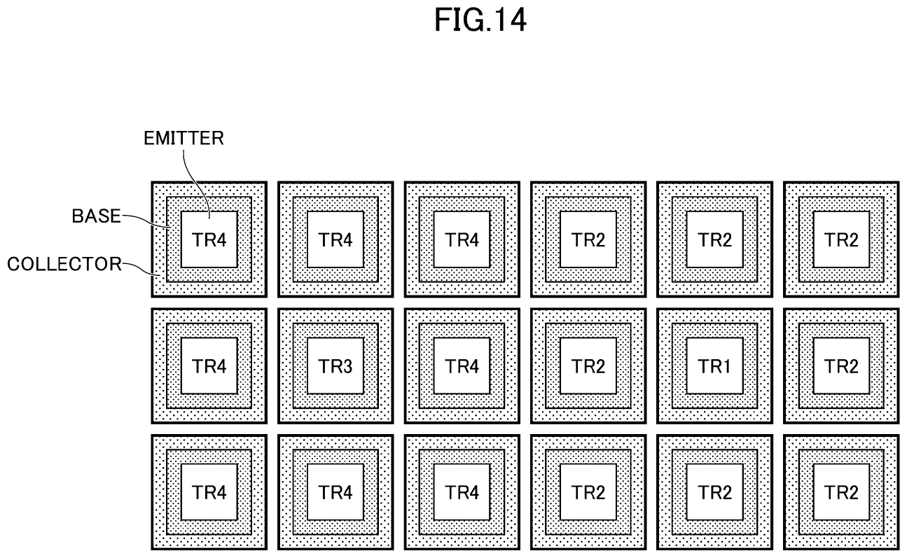

Here, in the present embodiment, as a suitable example, A=B and M=N are established. For example, A=B=1 and M=N=8 are established. With this relationship, as illustrated in FIG. 14, the bipolar transistors TR1 and TR2 can be arranged in a square shape. Similarly, the transistors TR3 and TR4 can be arranged in a square shape. By arranging these bipolar transistors TR1, TR2, TR3, and TR4 close to each other, relative characteristic variations caused by manufacturing can be suppressed. Here, for convenience, the bipolar transistors TR2 and TR4 each include eight independent sections, but each of them is electrically connected.

Additionally, the reference voltage generation circuit 100 according to the first embodiment can suppress the relative characteristic variation caused by manufacturing, by the first resistor R1, the second resistor R2, and the sixth resistor R6 including the same type of resistors (for example, a poly resistor, a diffusion layer resistor, a metal resistor, or the like) so that the temperature characteristics are identical to each other.

The influence of the temperature characteristics of the bipolar transistors and the resistors dominates the high-order temperature characteristics of the reference voltage generation circuit, and thus the high-order temperature characteristics can be stably corrected by suppressing the relative characteristic variation of the bipolar transistors and the relative characteristic variation of the resistors.

### (Improvement Effect of Temperature Characteristic)

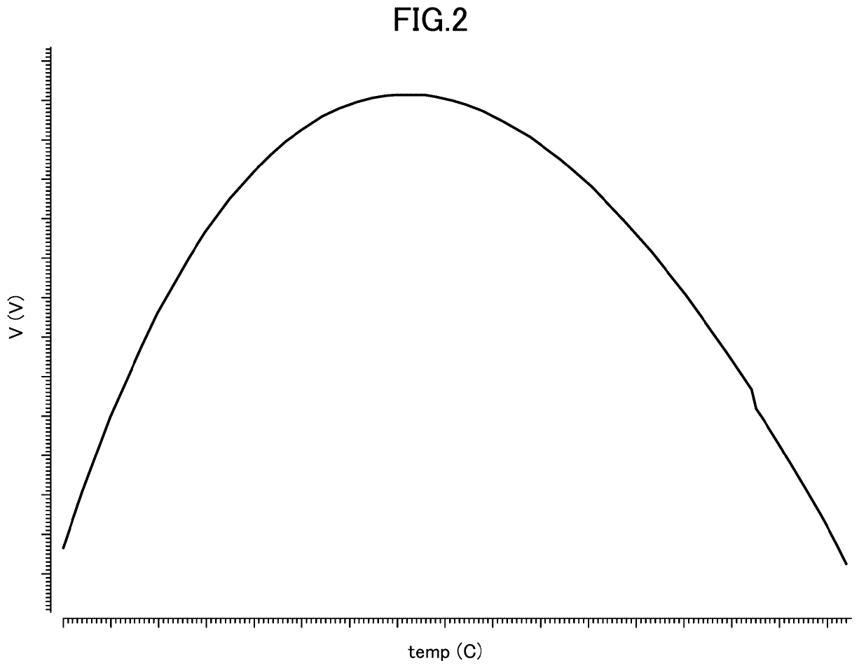

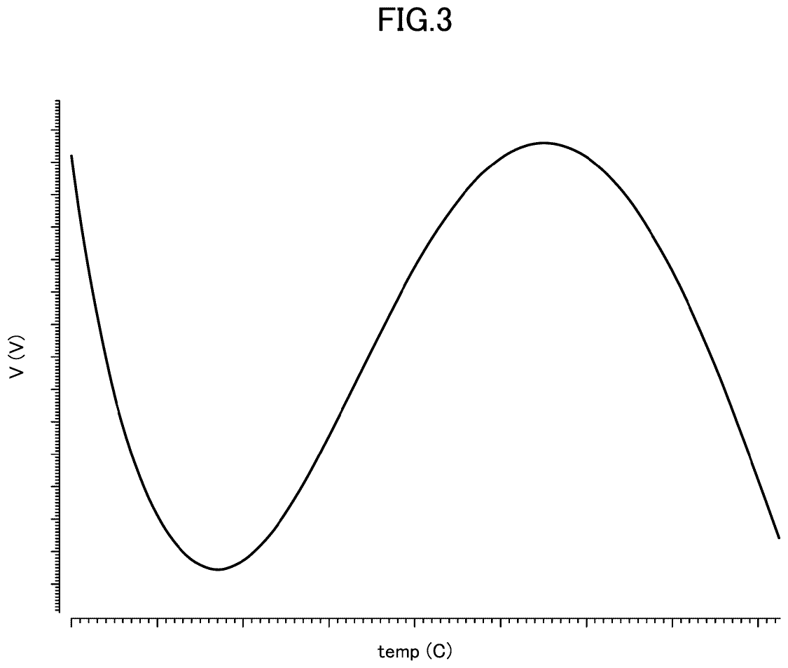

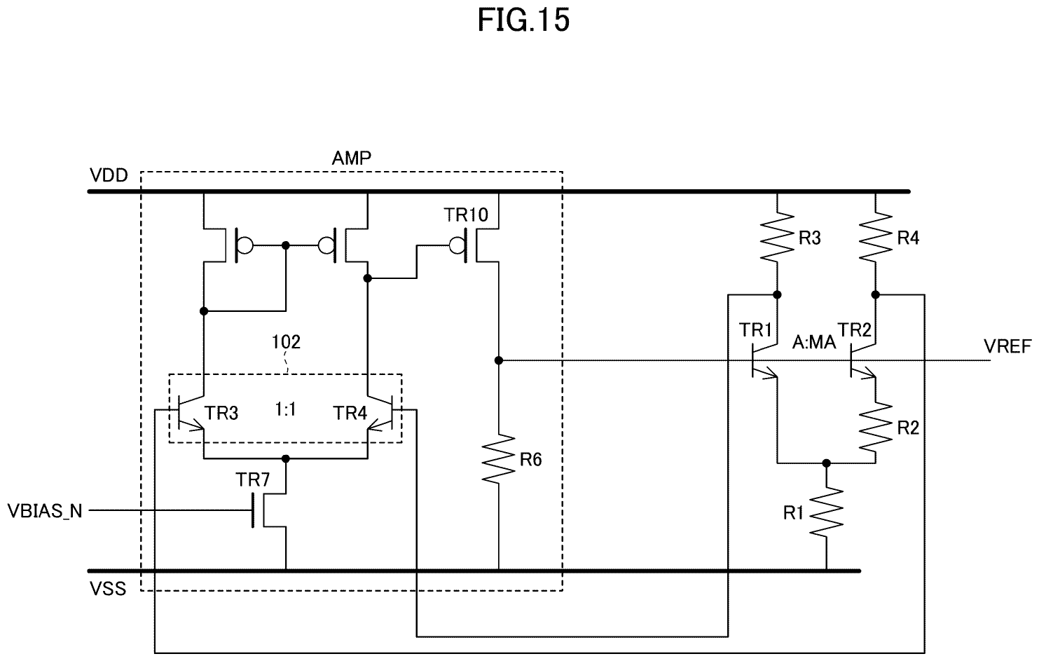

FIG. 2 is a graph indicating an example of the temperature characteristic of the band gap reference voltage in a reference voltage generation circuit of a comparative example illustrated in FIG. 15. FIG. 3 is a graph indicating an example of the temperature characteristic of the band gap reference voltage in the reference voltage generation circuit 100 according to the first embodiment. In the graphs illustrated in FIGS. 2 and 3, the horizontal axis represents the environmental temperature [° C.], and the vertical axis represents the voltage [V].

As illustrated in FIG. 2, in the reference voltage generation circuit of the comparative example, the temperature characteristic of the band gap reference voltage has an upwardly convex shape, and the change in the voltage [V] is approximately 2-5 [mV] in the environmental temperature range of −40 [° C.] to 120 [° C.].

As illustrated in FIG. 3, in the reference voltage generation circuit 100 of the first embodiment, the temperature characteristic of the band gap reference voltage has a downwardly concave shape and an upwardly convex shape, and the change in the voltage [V] is approximately 250 [μV] in the environmental temperature range of −40 [° C.] to 120 [° C.].

As described above, in the reference voltage generation circuit 100 of the first embodiment, the change in the voltage [V] due to the change of environmental temperature is suppressed in comparison with the reference voltage generation circuit of the comparative example, by providing the first current source as an example of the temperature compensation circuit.

### First Modified Example of First Embodiment

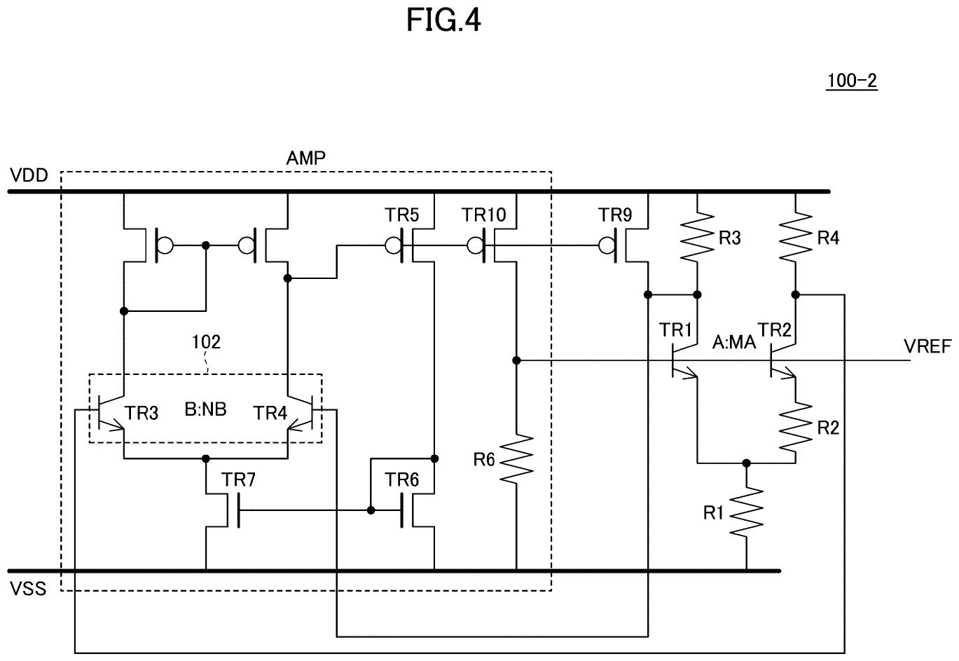

FIG. 4 is a diagram illustrating a first modified example of the circuit configuration of the reference voltage generation circuit 100 according to the first embodiment. A reference voltage generation circuit 100-2 illustrated in FIG. 4 differs from the reference voltage generation circuit 100 in the connection of the gate of a transistor TR7.

As illustrated in FIG. 4, in addition to the configuration in which the MOS transistor TR10 and the sixth resistor R6 are connected in series, a third PMOS transistor TR5 (i.e., a third current source) and an NMOS transistor TR6 are connected in series. Specifically, the source of the third PMOS transistor TR5 is connected to the first power supply terminal VDD. The drain of the third PMOS transistor TR5 is connected to the drain and the control terminal of the NMOS transistor TR6 and the gate of the transistor TR7. The source of the NMOS transistor TR6 is connected to the second power supply terminal VSS.

### Second Embodiment

### (Circuit Configuration of Reference Voltage Generation Circuit 200)

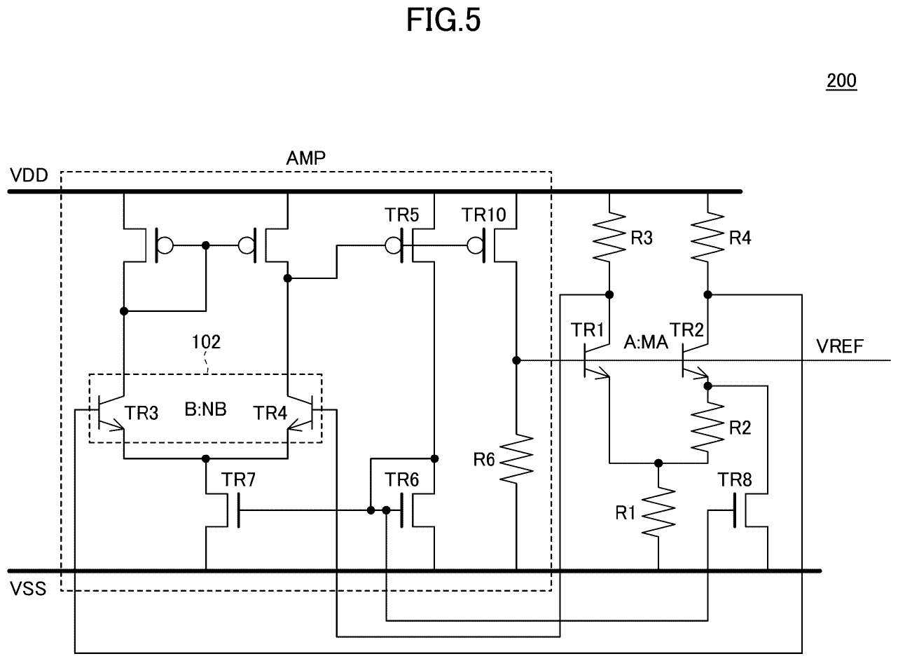

FIG. 5 is a diagram illustrating an example of a circuit configuration of a reference voltage generation circuit 200 according to a second embodiment. The reference voltage generation circuit 200 illustrated in FIG. 5 is different from the reference voltage generation circuit 100-2 illustrated in FIG. 4 in that the first current source (the transistor TR9), which is an example of the temperature compensation circuit, is not included. The reference voltage generation circuit 200 illustrated in FIG. 5 is different from the reference voltage generation circuit 100-2 illustrated in FIG. 4 in that a second current source (an NMOS transistor TR8) connected to the emitter of the second bipolar transistor TR2 is included as the temperature compensation circuit.

As illustrated in FIG. 5, the NMOS transistor TR8 is provided between the second bipolar transistor TR2 and the second power supply terminal VSS. Specifically, the control terminal of the NMOS transistor TR8 is connected to the control terminal of the NMOS transistor TR6. One end of the NMOS transistor TR8 is connected to the second power supply terminal VSS. The other end of the NMOS transistor TR8 is connected to the emitter of the second bipolar transistor TR2.

That is, as an example of the temperature compensation circuit for correcting the current of the emitter of the second bipolar transistor TR2, the second current source (the NMOS transistor TR8) connected to the emitter of the second bipolar transistor TR2 is included.

The reference voltage generation circuit 200 according to the second embodiment can improve the temperature characteristic of the band gap reference voltage by correcting the current of the emitter of the second bipolar transistor TR2 with the second current source (the NMOS transistor TR8). Additionally, the reference voltage generation circuit 200 according to the second embodiment does not use a comparator, amplifier, or the like for the temperature compensation circuit, thereby suppressing an increase in power consumption caused by the addition of the temperature compensation circuit.

### (Improvement Effect in Temperature Characteristic)

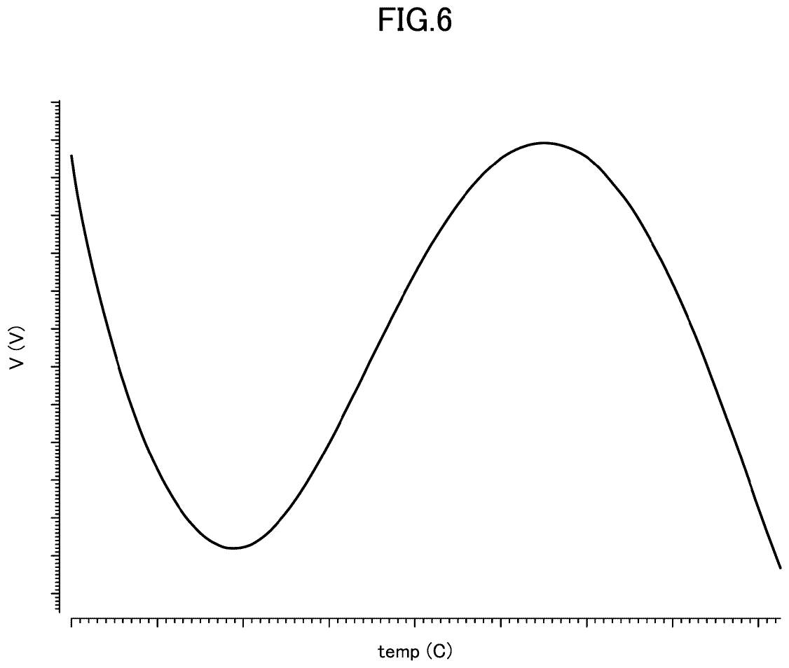

FIG. 6 is a graph indicating an example of the temperature characteristic of the band gap reference voltage in the reference voltage generation circuit 200 according to the second embodiment. In the graph illustrated in FIG. 6, the horizontal axis represents the environmental temperature [° C.], and the vertical axis represents the voltage [V].

As illustrated in FIG. 2, in the reference voltage generation circuit of the comparative example, the temperature characteristic of the band gap reference voltage has an upwardly convex shape, and the change in voltage [V] is approximately 2-5 [mV] in the environmental temperature range of −40 [° C.] to 120 [° C.].

As illustrated in FIG. 6, in the reference voltage generation circuit 200 according to the second embodiment, the temperature characteristic of the band gap reference voltage has a downwardly concave shape and an upwardly convex shape, and the change in the voltage [V] is approximately 250 [μV] in the environmental temperature range of −40 [° C.] to 120 [° C.].

As described above, in the reference voltage generation circuit 200 according to the second embodiment, by providing the second current source as an example of the temperature compensation circuit, the change of voltage [V] due to the change in the environmental temperature is suppressed in comparison with the reference voltage generation circuit of the comparative example.

### Second Modified Example Combining First Embodiment and Second Embodiment

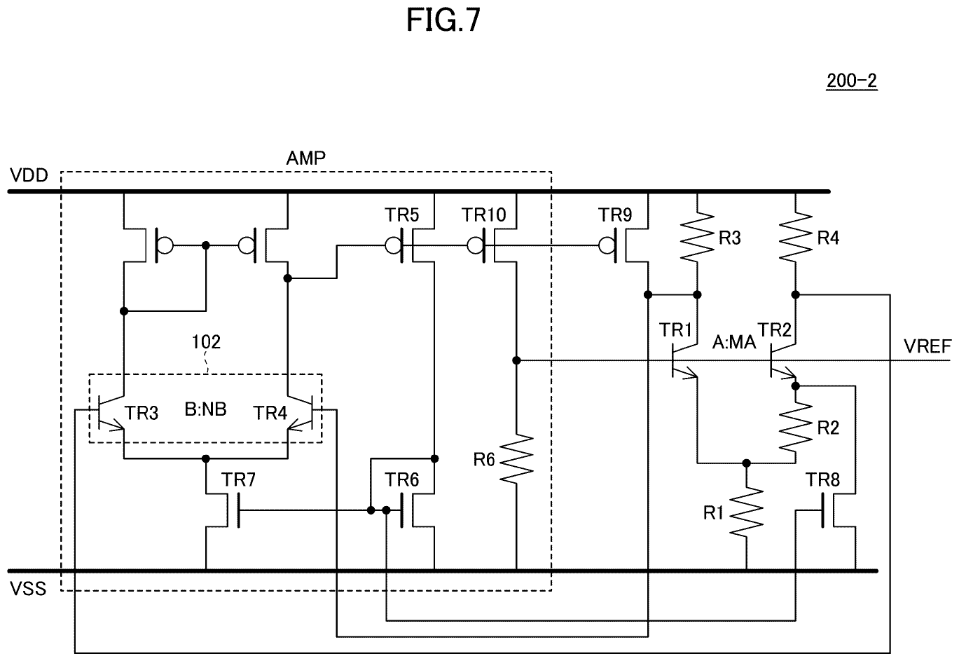

FIG. 7 is a diagram illustrating a second modified example combining the first embodiment and the second embodiment. A reference voltage generation circuit 200-2 illustrated in FIG. 7 is different from the reference voltage generation circuit 100-2 illustrated in FIG. 4 in that the NMOS transistor TR8 is further included as the second current source, which is the temperature compensation circuit of the second embodiment, in the first modified example of the first embodiment.

As illustrated in FIG. 7, the second current source (the NMOS transistor TR8) is added to the reference voltage generation circuit 100-2 according to the modified example of the first embodiment.

As described above, the reference voltage generation circuit 200-2 according to the second modified example combining the first embodiment and the second embodiment includes the first current source (the transistor TR9) connected to the collector of the first bipolar transistor TR1 as an example of the temperature compensation circuit for correcting the current of the collector of the first bipolar transistor TR1, and the second current source (the NMOS transistor TR8) connected to the emitter of the second bipolar transistor TR2 as an example of the temperature compensation circuit for correcting the current of the emitter of the second bipolar transistor TR2.

With this, the reference voltage generation circuit 200-2 according to the second modified example combining the first embodiment and the second embodiment can improve the temperature characteristic of the bandgap reference voltage by correcting both the current of the collector of the first bipolar transistor TR1 and the current of the emitter of the second bipolar transistor TR2 in accordance with the change in the environmental temperature. Additionally, the reference voltage generation circuit 200-2 according to the second modified example combining the first embodiment and the second embodiment does not use a comparator, amplifier, or the like for the temperature compensation circuit, thereby suppressing an increase in power consumption caused by the addition of the temperature compensation circuit.

### Third Embodiment

(Circuit Configuration of Reference Voltage Generation circuit 300)

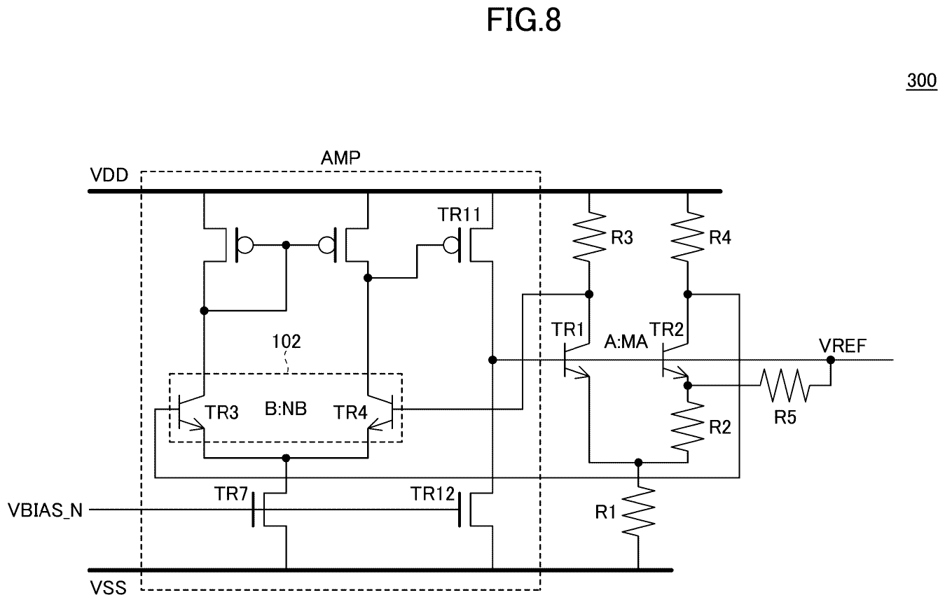

FIG. 8 is a diagram illustrating an example of a circuit configuration of a reference voltage generation circuit 300 according to a third embodiment. The reference voltage generation circuit 300 illustrated in FIG. 8 is different from the reference voltage generation circuit 100 illustrated in FIG. 1 in that the first current source (the transistor TR9), which is an example of the temperature compensation circuit is not included, but instead, a resistance element R5 connected to the emitter of the second bipolar transistor TR2 is included as another example of the temperature compensation circuit. Specifically, one end of the resistance element R5 is connected to the emitter of the second bipolar transistor TR2, and the other end is connected to the output terminal VREF.

Additionally, the reference voltage generation circuit 300 illustrated in FIG. 8 is different from the reference voltage generation circuit 100 illustrated in FIG. 1 in the following points. Specifically, the reference voltage generation circuit 300 has a configuration in which a PMOS transistor TR11 and an NMOS transistor TR12 are connected in series. One end of the PMOS transistor TR11 is connected to the first power supply terminal VDD. The other end of the PMOS transistor TR11 is connected to one end of the NMOS transistor TR12. The other end of the NMOS transistor TR12 is connected to the second power supply terminal VSS.

The reference voltage generation circuit 300 according to the third embodiment can improve the temperature characteristic of the band gap reference voltage by correcting the current of the emitter of the second bipolar transistor TR2 with the resistance element R5. Additionally, the reference voltage generation circuit 300 according to the third embodiment does not use a comparator, amplifier, or the like for the temperature compensation circuit, thereby suppressing an increase in power consumption caused by the addition of the temperature compensation circuit.

### (Improvement Effect of in Temperature Characteristic)

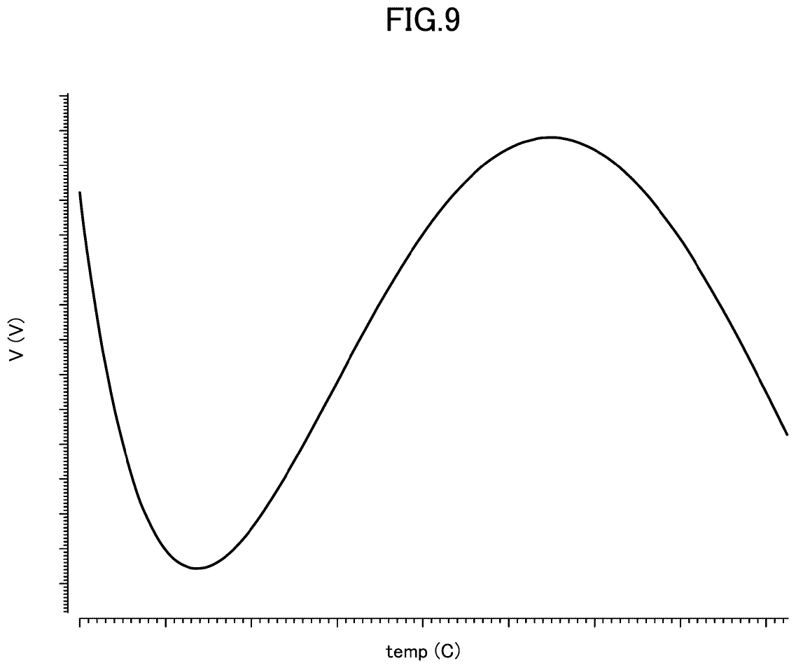

FIG. 9 is a graph indicating an example of the temperature characteristic of the band gap reference voltage in the reference voltage generation circuit 300 according to the third embodiment. In the graph illustrated in FIG. 9, the horizontal axis represents the environmental temperature [° C.], and the vertical axis represents the voltage [V].

As illustrated in FIG. 2, in the reference voltage generation circuit of the comparative example, the temperature characteristic of the band gap reference voltage has an upwardly convex shape, and the change in the voltage [V] is approximately 2-5 [mV] in the environmental temperature range of −40 [° C.] to 120 [° C.].

With respect to the above, as illustrated in FIG. 9, in the reference voltage generation circuit 300 of the third embodiment, the temperature characteristic of the band gap reference voltage has a downwardly concave shape and an upwardly convex shape, and the change in the voltage [V] is approximately 300 [μV] in the environmental temperature range of −40 [° C.] to 120 [° C.].

As described above, in the reference voltage generation circuit 300 of the third embodiment, the change in the voltage [V] due to the change in the environmental temperature is suppressed in comparison with the reference voltage generation circuit of the comparative example by providing the resistance element R5 as an example of the temperature compensation circuit.

Here, in the reference voltage generation circuit 300 according to the third embodiment, the second resistor R2 and the resistance element R5 are formed of the same type of resistors (for example, a poly resistor, a diffusion layer resistor, a metal resistor, or the like) so that the temperature characteristics are identical to each other.

### (Operation of Reference Voltage Generation Circuit 300 According to Third Embodiment)

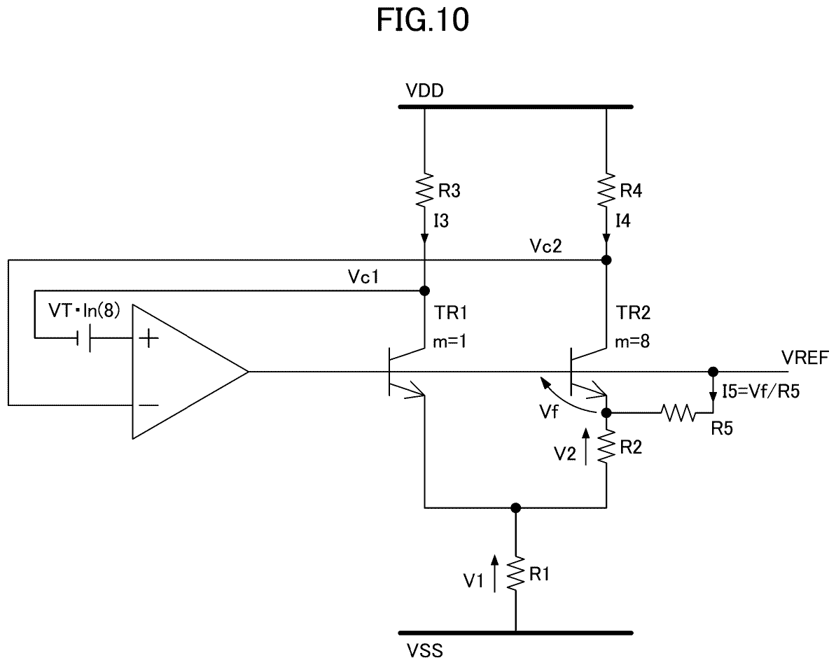

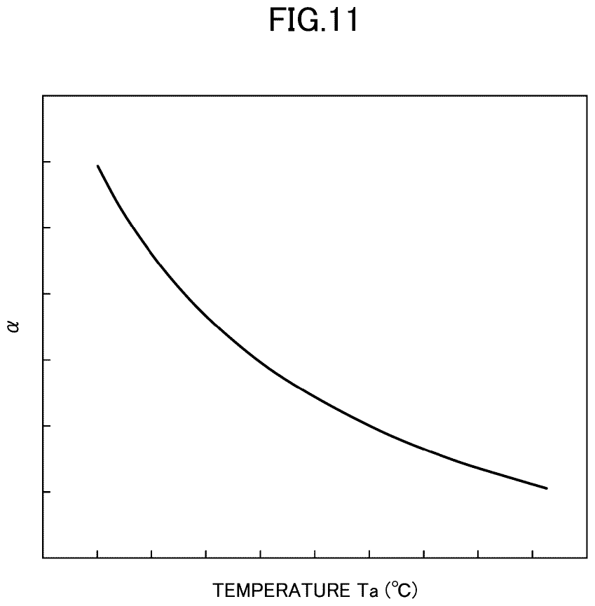

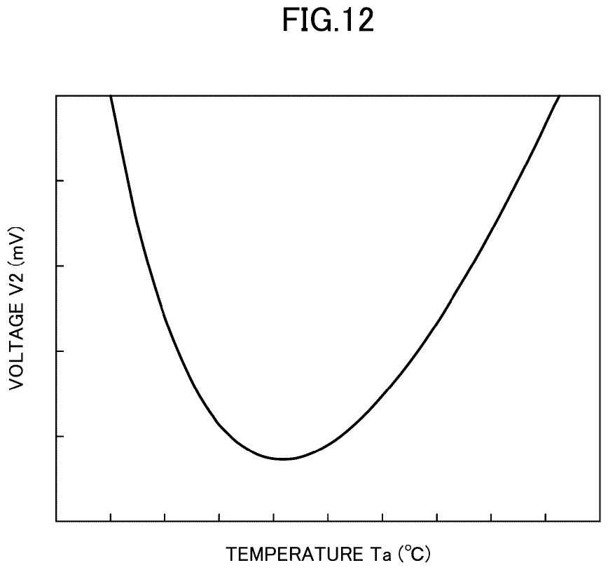

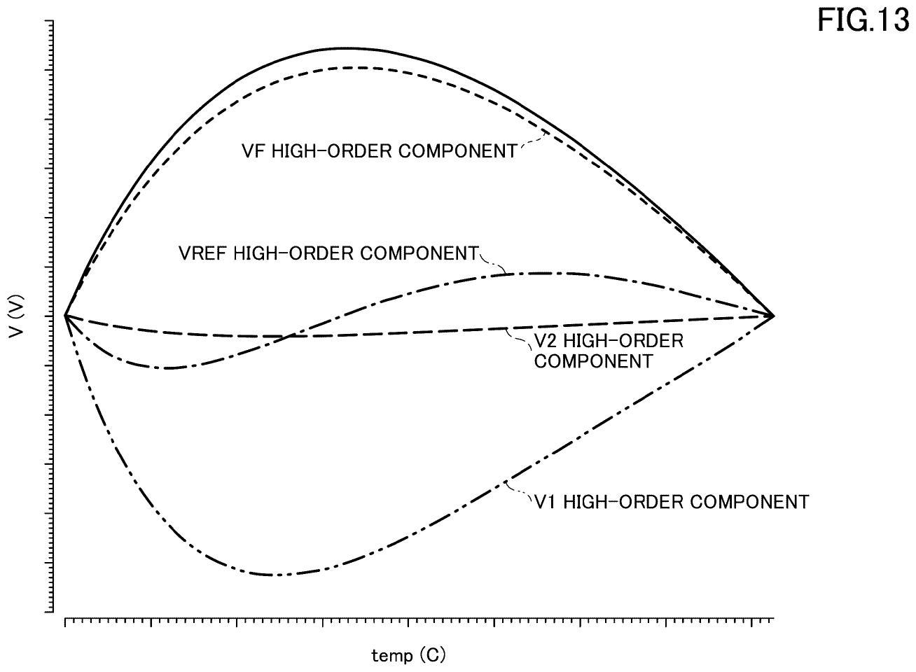

The operation of the reference voltage generation circuit 300 according to the third embodiment will be described below with reference to FIGS. 10 to 13. FIG. 10 is a diagram illustrating a configuration of an equivalent circuit of the reference voltage generation circuit 300 according to the third embodiment. FIG. 11 is a graph indicating the temperature characteristic of the current ratio a of the current I3 to the current I4 in the equivalent circuit illustrated in FIG. 10. FIG. 12 is a graph indicating the high-order component of the voltage V2 generated in the second resistor R2 in the equivalent circuit illustrated in FIG. 10. FIG. 13 is a graph illustrating the high-order component of the temperature characteristic of each voltage in the equivalent circuit illustrated in FIG. 10.
(1) First, in the equivalent circuit illustrated in FIG. 10, the current ratio x of the current I3 to the current I4 is obtained when the current I5 depending on Vf is caused to flow into the second resistor R2 of the Brokaw-type reference voltage source and the amplifier has an offset voltage of VT×ln(8). Here, VT is the thermal voltage. It is assumed that I3:I4=α:1 and I3=α×I4.

From the current ratio α, the voltage V2 generated in the second resistor R2 can be obtained by Equation (1) below.

$$[ Equation 1 ]$$

$$V 2 = VT \times ln ( 8 α ) \qquad ( 1 )$$

The voltage V2 is obtained by the current I5=Vf/R5, and thus the current I4 can be obtained by Equation (2) below.

$$[ Equation 2 ]$$

$$I 4 = \frac{VT \times ln ( 8 α )}{R 2} - \frac{Vf}{R 5} \qquad ( 2 )$$

From the current ratio α, the current I3 can be obtained by Equation (3) below.

$$[ Equation 3 ]$$

$$I 3 = α \times ( \frac{VT \times ln ( 8 α )}{R 2} - \frac{Vf}{R 5} ) \qquad ( 3 )$$

The amplifier has an offset voltage VT×ln(8), and thus the relationship between Vc1 and Vc2 is expressed by Equation (4) below.

$$[ Equation 4 ]$$

$$Vc 2 - Vc 1 = VT \times ln ( 8 ) \qquad ( 4 )$$

Equation (5) below holds from Equation (2), Equation (3), and Equation (4) above.

$$[ Equation 5 ]$$

$$\begin{matrix}Vc 2 - Vc 1 = ( VDD - R 4 \times I 4 ) - ( VDD - R 3 \times I 3 ) \\ = - R 4 \{ \frac{VT \times ln ( 8 α )}{R 2} - \frac{Vf}{R 5} \} + α R 3 \{ \frac{VT \times ln ( 8 α )}{R 2} - \frac{Vf}{R 5} \} \\ R 3 = R 4 = Rc \\ Vc 2 - Vc 3 = ( α - 1 ) R c \{ \frac{VT \times ln ( 8 α )}{R 2} - \frac{Vf}{RS} \} = VT \times ln ( 8 )\end{matrix} \qquad ( 5 )$$

Additionally, when α=1+Δα, ln(8×α) is expressed by Equation (6) below from the approximate equation ln(1+Δα)≈Δα when Δα is sufficiently small.

$$ln ( 8 \times α ) = ln ( 8 ) + ln ( α ) = ln ( 8 ) + ln ( 1 + Δα ) ln ( 8 ) + Δα$$

Equation (7) below holds from Equation (5) and Equation (6) above.

$$[ Equation 7 ]$$

$$Rc \times Δα \times ( \frac{VT \times ( ln ( 8 ) + Δα )}{R 2} - \frac{Vf}{R 5} ) = VT \times ln ( 8 ) \qquad ( 7 )$$

If the term Δα² is ignored because it is sufficiently small, Equation (8) below is obtained.

$$[ Equation 8 ]$$

$$Δα \frac{VT \times ln ( 8 )}{\frac{Rc}{R 2} \times VT \times ln ( 8 ) - \frac{Rc}{R 5} \times VF} \qquad ( 8 )$$

Therefore, from α=1+Δα, the current ratio α is expressed by Equation (9) below.

$$[ Equation 9 ]$$

$$α = 1 + Δα 1 + \frac{VT \times ln ( 8 )}{\frac{Rc}{R 2} \times VT \times ln ( 8 ) - \frac{Rc}{R 5} \times Vf} \qquad ( 9 )$$

(2) Next, the voltage V2 generated in the second resistor R2 is obtained from the current ratio α. From Equation (9) above, the voltage V2 is expressed by Equation (10) below.

$$[ Equation 10 ]$$

$$\begin{matrix}V 2 = VT \times ln ( 8 α ) = V T \times ln ( 8 ) + VT \times ln ( α ) \\ = VT \times ln ( 8 ) + VT \times ln ( 1 + Δα ) \\ VT \times ln ( 8 ) + VT \times Δα \\ VT \times ln ( 8 ) + VT \times \frac{VT \times ln ( 8 )}{\frac{Rc}{R 2} \times VT \times ln ( 8 ) - \frac{Rc}{R 5} \times Vf}\end{matrix} \qquad ( 10 )$$

As illustrated in FIG. 11, the current ratio α of Equation (9) above has a high-order component. Additionally, as illustrated in FIG. 12, the second term of Equation (10) above has a high-order component that has a downwardly concave shape.
(3) Next, the bandgap reference voltage output voltage VREF is obtained from the current ratio α.

From the current ratio α, the voltage V2 generated in the second resistor R2 can be obtained by Equation (11) below.

$$[ Equation 11 ]$$

$$V 2 = VT \times ln ( 8 α ) \qquad ( 11 )$$

Therefore, the current I4 can be obtained by Equation (12) below.

$$[ Equation 12 ]$$

$$I 4 = \frac{VT \times ln ( 8 α )}{R 2} - \frac{Vf}{R 5} \qquad ( 12 )$$

From the current I4, Vc2 is expressed by Equation (13) below.

$$[ Equation 13 ]$$

$$Vc 2 = VDD - \{ \frac{Rc}{R 2} \times VT \times ln ( 8 α ) - \frac{Rc}{R 5} \times Vf \} \qquad ( 13 )$$

The amplifier has an offset voltage VT×ln (8), and thus Vc1 can be obtained by Equation (14) below.

$$[ Equation 14 ]$$

$$Vc 1 = Vc 2 - VT \times ln ( 8 ) = VDD - \frac{Rc}{R 2} \times VT \times ln ( 8 α ) + \frac{Rc}{R 5} \times Vf - VT \times ln ( 8 ) \qquad ( 14 )$$

Therefore, the current I3 can be obtained by Equation (15) below.

$$[ Equation 15 ]$$

$$I 3 = \frac{VDD - Vc 1}{Rc} = \frac{VT \times ln ( 8 α )}{R 2} - \frac{Vf}{R 5} + \frac{VT \times ln ( 8 )}{Rc} \qquad ( 15 )$$

Additionally, the current I1 can be obtained by Equation (16) below.

$$[ Equation 16 ]$$

$$\begin{matrix}I 1 = I 3 + I 4 + I 5 = \{ \frac{VT \times ln ( 8 α )}{R 2} - \frac{Vf}{R 5} + \frac{VT \times ln ( 8 )}{Rc} \} + \{ \frac{VT \times ln ( 8 α )}{R 2} - \frac{Vf}{R 5} \} + \{ \frac{Vf}{R 5} \} \\ = \frac{2}{R 2} \times VT \times ln ( 8 α ) - \frac{Vf}{R 5} + \frac{1}{Rc} \times VT \times ln ( 8 )\end{matrix} \qquad ( 16 )$$

Additionally, the voltage V1 can be obtained by Equation (17) below.

$$[ Equation 17 ]$$

$$V 1 = I 1 \times R 1 = \frac{2 R 1}{R 2} \times VT \times ln ( 8 α ) - \frac{R 1}{R 5} \times Vf + \frac{R 1}{Rc} \times VT \times ln ( 8 ) \qquad ( 17 )$$

Additionally, the voltage VREF can be obtained by Equation (18) below.

$$[ Equation 18 ]$$

$$\begin{matrix}VREF = V 1 + V 2 + Vf = \{ \frac{2 R 1}{R 2} \times VT \times ln ( 8 α ) - \frac{R 1}{R 5} \times Vf \times \frac{R 1}{Rc} \times VT \times ln ( 8 ) \} + \{ VT \times ln ( 8 α ) \} + Vf \\ = ( \frac{2 R 1}{R 2} + 1 ) \times VT \times ln ( 8 α ) + ( 1 - \frac{R 1}{R 5} ) \times Vf + \frac{R 1}{Rc} \times VT \times ln ( 8 )\end{matrix} \qquad ( 18 )$$

As illustrated in FIG. 13, the temperature characteristic of the voltage VREF is flattened by the high-order component of the first term that is upwardly convex and the high-order component of the second term that is downwardly concave in Equation (18) above.

Although the embodiments of the present invention have been described in detail above, the present invention is not limited to these embodiments, and various modifications or changes can be made within the scope of the gist of the present invention described in the claims.

In each of the reference voltage generation circuits described in the embodiments, an amplifier AMP having a configuration other than that described in the embodiment may be used. For example, in the reference voltage generation circuit 100 according to the first embodiment, an amplifier AMP having a configuration in which the NMOS load of the second-stage output of the two-stage amplifier is replaced by the sixth resistor R6 is used, but an amplifier AMP having another configuration (for example, a configuration of a two-stage amplifier (see FIG. 8), a configuration in which the first stage of the two-stage amplifier is replaced by a folded cascode, or the like) may be used. However, in any one of the configurations of the amplifier AMP, it is preferable that the emitter area ratio of the inverting input transistor TR3 and the non-inverting input transistor TR4 included in the amplifier AMP is B:N*B with different current densities.

What is claimed is:

1. A reference voltage generation circuit comprising:
an output terminal configured to output a reference voltage;
a first bipolar transistor and a second bipolar transistor, both of which are connected between a first power supply terminal and a second power supply terminal, a base of the first bipolar transistor and a base of the second bipolar transistor being connected to the output terminal;
a first resistor connected between the second power supply terminal and an emitter of the first bipolar transistor;
a second resistor connected in series between an end of the first resistor and an emitter of the second bipolar transistor, the end of the first resistor being connected to the emitter of the first bipolar transistor;
a third resistor connected between the first power supply terminal and a collector of the first bipolar transistor;
a fourth resistor connected between the first power supply terminal and a collector of the second bipolar transistor;
an amplifier using the collector of the first bipolar transistor and the collector of the second bipolar transistor as input, an output of the amplifier being connected to the output terminal; and
a temperature compensation circuit configured to correct a current of the collector or emitter of the second bipolar transistor or a current of the collector or emitter of the first bipolar transistor.

2. The reference voltage generation circuit as claimed in claim 1,
wherein the amplifier includes a differential pair in which a ratio of a current density of an emitter of an inverting input transistor to a current density of an emitter of a non-inverting input transistor is N*B:B,
wherein the collector of the first bipolar transistor is connected to the non-inverting input transistor, and the collector of the second bipolar transistor is connected to the inverting input transistor, and
wherein a ratio of a current density of the emitter of the first bipolar transistor to a current density of the emitter of the second bipolar transistor is M*A:A, where A and B are real numbers greater than or equal 1 and M and N are real numbers greater than 1.

3. The reference voltage generation circuit as claimed in claim 1,
wherein the amplifier includes a differential pair in which a ratio of an area of an emitter of an inverting input transistor to an area of an emitter of a non-inverting input transistor is B:N*B,
wherein the collector of the first bipolar transistor is connected to the non-inverting input transistor, and the collector of the second bipolar transistor is connected to the inverting input transistor, and
wherein a ratio of an area of the emitter of the first bipolar transistor to an area of the emitter of the second bipolar transistor is A:M*A, where A and B are real numbers greater than or equal to 1 and M and N real numbers greater than 1.

4. The reference voltage generation circuit as claimed in claim 2, wherein A=B and M=N are established.

5. The reference voltage generation circuit as claimed in claim 2, wherein the temperature compensation circuit includes a first current source connected to the collector or emitter of the first bipolar transistor.

6. The reference voltage generation circuit as claimed in claim 5,
wherein the amplifier includes an emitter coupling pair including a first transistor and a second transistor, a control terminal of the first transistor being an inverting input, and a control terminal of the second transistor being a non-inverting input, and
wherein the amplifier includes a MOS transistor connected between the first power supply terminal and the second power supply terminal, an input of the MOS transistor being connected to the collector of the non-inverting input transistor of the amplifier, and a drain of the MOS transistor being connected to the output terminal.

7. The reference voltage generation circuit as claimed in claim 6, wherein the first current source includes a transistor, one end of the transistor being connected to the first power supply terminal, another end of the transistor being connected to the collector of the first bipolar transistor, and a control terminal of the transistor being connected to the control terminal of the MOS transistor.

8. The reference voltage generation circuit as claimed in claim 2, wherein the temperature compensation circuit includes a second current source connected to the emitter of the second bipolar transistor.

9. The reference voltage generation circuit as claimed in claim 8, comprising a third PMOS current source and an NMOS transistor, a drain of the third PMOS current source being commonly connected to a drain and a control terminal of the NMOS transistor,
wherein a control terminal of the second current source is connected to a control terminal of the NMOS transistor, one end of the second current source is connected to the second power supply terminal, and another end of the second current source is connected to the emitter of the second bipolar transistor.

10. The reference voltage generation circuit as claimed in claim 2, wherein the temperature compensation circuit includes a resistance element, one end of the resistance element being connected to the emitter of the second bipolar transistor, and another end of the resistance element being connected to the output terminal.

11. The reference voltage generation circuit as claimed in claim 10,
wherein the second resistor and the resistance element are formed of a same type of resistor, and
wherein A=B and M=N are established.

12. The reference voltage generation circuit as claimed in claim 2, wherein the temperature compensation circuit includes:
a first current source connected to the collector of the first bipolar transistor; and
a second current source connected to the emitter of the second bipolar transistor.

13. The reference voltage generation circuit as claimed in claim 12,
wherein the amplifier includes:
an emitter coupling pair including a first transistor and a second transistor, a control terminal of the first transistor being an inverting input, and a control terminal of the second transistor being a non-inverting input; and
a MOS transistor connected between the first power supply terminal and the second power supply terminal, a control terminal of the MOS transistor being connected to a collector of the second transistor of the amplifier, and a drain of the MOS transistor being connected to the output terminal.

14. The reference voltage generation circuit as claimed in claim 13,
wherein the first current source includes a transistor, one end of the transistor of the first current source being connected to the first power supply terminal, another end of the transistor of the first current source being connected to the collector of the first bipolar transistor, and a control terminal of the transistor of the first current source being connected to the control terminal of the MOS transistor,
wherein the reference voltage generation circuit includes a third PMOS current source and an NMOS transistor, a drain of the third PMOS current source being commonly connected to a drain and a control terminal of the NMOS transistor, and
wherein the second current source includes a transistor, a control terminal of the transistor of the second current source being connected to the control terminal of the NMOS transistor, one end of the transistor of the second current source being connected to the second power supply terminal, and another end of the transistor of the second current source being connected to the emitter of the second bipolar transistor.
